(19) United States
(12) Patent Application Publication
(10) Pub. No.: US 2004/0252293 A1
(43) Pub. Date: Dec. 16, 2004

(54) Alignment apparatus

(76) Inventors: Walter Laver, Coventry (GB); Ian Garner, Coventry (GB)

Correspondence Address: OLIFF & BERRIDGE, PLC, P.O. BOX 19928, ALEXANDRIA, VA, 22320, US

(21) Appl. No.: 10/492,854

(22) PCT Filed: Oct. 16, 2002
(86) PCT No.: PCT/GB02/04659

Related U.S. Application Data
(60) Provisional application No. 60/371,685, filed on Apr. 12, 2002.

(30) Foreign Application Priority Data
Oct. 16, 2001 (GB) 0124747.7
Apr. 13, 2002 (GB) 0208567.8
Jul. 19, 2002 (GB) 0216820.1

(51) Int. Cl. G01B 11/26

(52) U.S. Cl. 356/138

(57) ABSTRACT

An alignment apparatus for aligning a device, such as a tool or other implement, at a desired angle with respect to a flat surface, comprises a light source for generating a beam of light and means for splitting the beam of light into a plurality of beams for projection onto the surface. The plurality of beams form a pattern of markers or indicators on the surface which changes if the orientation of the apparatus with respect to the surface changes. The apparatus is particularly suitable for aligning a drill or other tool with a wall or other flat fixture.

The present invention relates to an alignment apparatus and particularly, but not exclusively, to an apparatus for aligning a device, such as a tool or other implement, at a desired angle with respect to a flat surface. The invention also relates to a method and apparatus for refracting light, in one embodiment to a method and apparatus for splitting a single beam of light into a plurality of beams which, when projected onto a surface, define discrete points and/or straight lines.

There are many instances where it is desired to align an object at a predetermined angle relative to a flat surface. One example is in the alignment of a hand held tool, such as a drill or the like, with a wall or other fixture. Generally, it is desired to drill holes for screw fixings or the like substantially perpendicular to the wall. Misalignment of the drill can create difficulties in the mounting of such fixings and can even cause injury if the misaligned drill inadvertently bores through a region of the wall in which electricity cables are embedded.

Conventional methods of achieving alignment include the use of spirit levels, pendulums or other levelling devices. Disadvantages of such methods are that they do not easily lend themselves to use with tools such as power drills or the like and generally allow alignment in only one plane, i.e. either the vertical plane or the horizontal plane but not in both planes at the same time.

It is an object of the invention to provide an alignment apparatus which addresses these disadvantages.

According to a first aspect of the present invention, therefore, there is provided an apparatus for facilitating the alignment of an object with respect to a surface, the apparatus comprising means, mountable on said object, for providing a plurality of visible markers or indicators onto said surface in a predetermined pattern, configuration or spacing such that a change in the attitude or orientation of said object relative to said surface causes a change in the pattern, configuration or spacing of said indicators or markers on said surface.

Advantageously, said means may comprise alight source for projecting a beam of light and optical means for splitting the beam into a plurality of light beams.

Conveniently, the optical means may comprise a refractor or the like. The refractor may comprise a prism arranged to split the beam of light into 5 light beams.

The five light beams may be arranged as a central beam and four mutually diverging beams substantially equidistantly spaced about said central beam and generally at 90° to each other.

The apparatus advantageously enables an object, tool or other device to be aligned to a surface in both the horizontal and vertical planes and at substantially any angle within such planes hemispherically.

According to a second aspect of the present invention there is provided an apparatus for refracting a beam of light, the apparatus comprising prism means having a first end surface, a plurality of inclined side surfaces and a corresponding plurality of arcuate surfaces connecting the first end surface to a respective side surface, the arrangement being such that when the light beam is passed through the prism means and projected onto a surface, a predetermined pattern comprising a plurality of generally straight lines is displayed thereon.

In one embodiment, the predetermined pattern comprises two generally straight lines which intersect substantially at right angles.

The pattern may additionally include a plurality of discrete points or dots of light.

Advantageously, the apparatus may be arranged such that inclination thereof relative to the surface causes movement of one or more of the dots relative to the lines or vice versa.

Advantageously, the cross section of the prism means in a first plane may be substantially trapezoidal. The cross section of the prism means in a second plane may be substantially square.

The prism means may have four or more inclined side surfaces. The side surfices may be inclined relative to the first end surface and/or to an axis of the prism means at an angle of between 20° and 70°. Preferably, side surfaces are inclined relative to the first end surface at an angle of approximately 60°.

The prism means may be formed from a material having a refractive index of between 1.6 and 2.5. Advantageously, the prism means is formed from a material having a refractive index of between 1.7 and 1.22. Preferably, the prism means is formed from a material which does not exhibit double refraction.

Most preferably, the prism means is formed from spinel or equivalent synthetic materials having a refractive index of between 1.712 and 1.762.

Clearly, the apparatus according to the above-described second aspect of the invention can be substituted for the optical means of the apparatus according to the above-described first aspect of the invention.

The invention will now be described, by way of example only, with reference to the accompanying drawings in which:

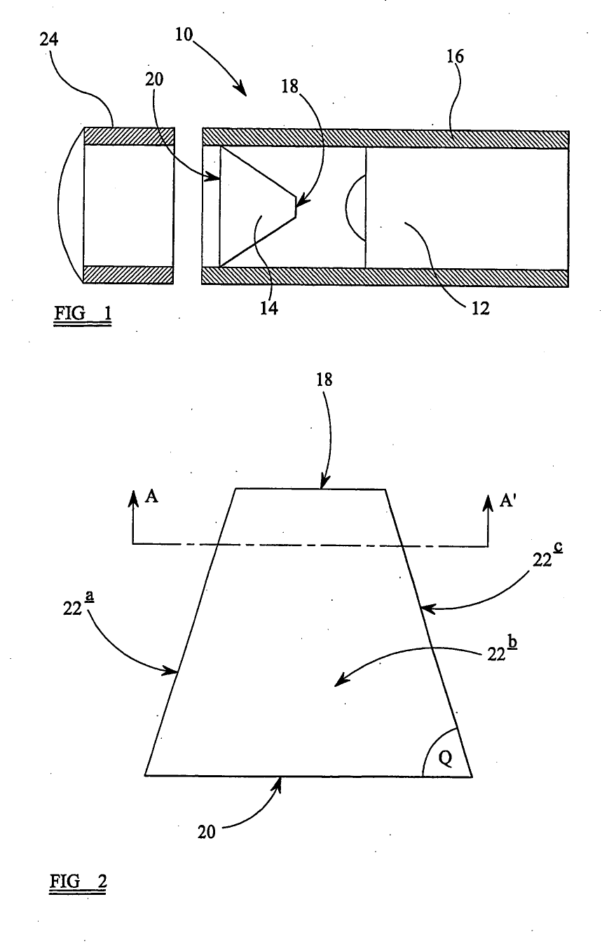

FIG. 1 is a schematic illustration of a preferred form of apparatus according to a first aspect of the invention;

FIG. 2 illustrates a first form of optical means for use with the apparatus of FIG. 1;

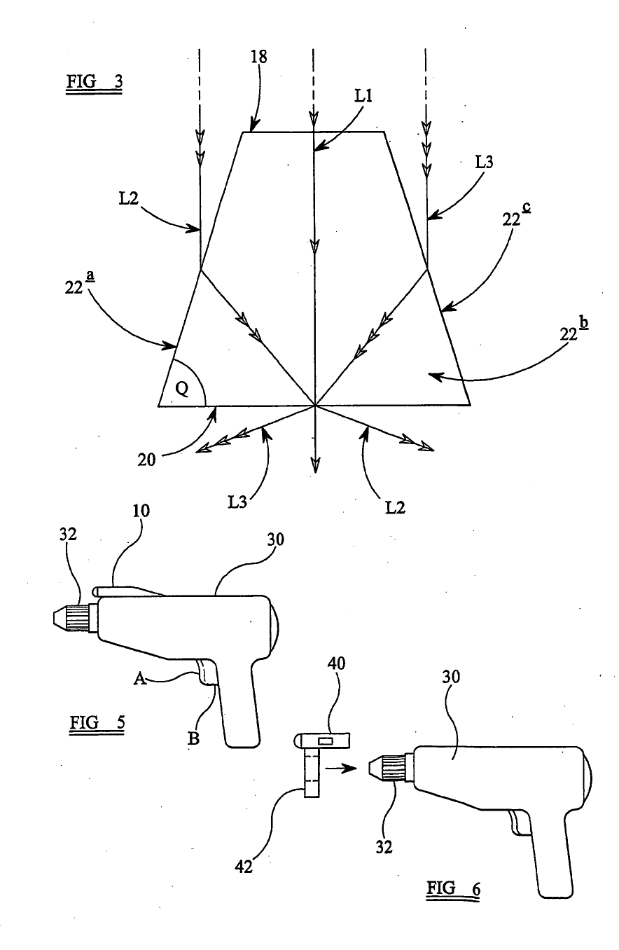

FIG. 3 illustrates operation of the optical means of FIG. 2;

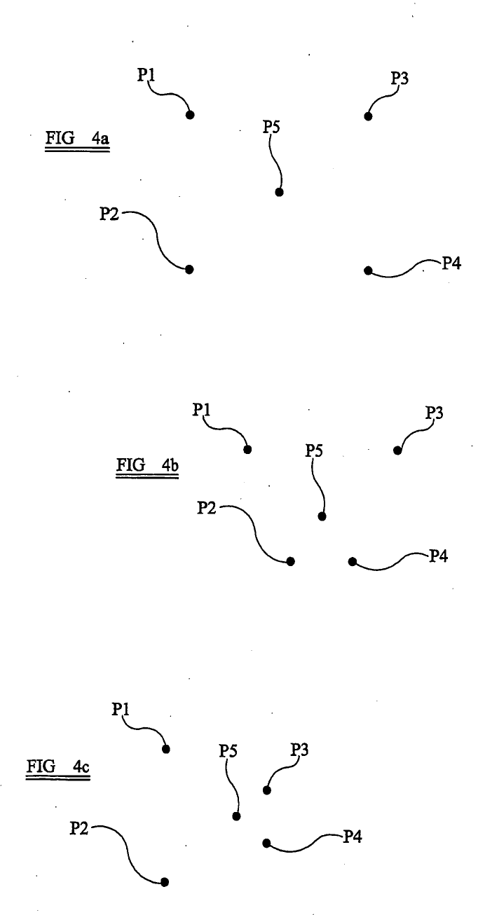

FIG. 4a-4c illustrate examples of marker or indicator patterns produced by the apparatus of FIG. 1 having the optical means of FIG. 2 at various inclinations to a surface;

FIG. 5 illustrates how the apparatus of FIG. 1 may be incorporated with a hand held drill;

FIG. 6 illustrates an embodiment in which the apparatus of FIG. 1 takes the form of a separate attachment for a hand held drill;

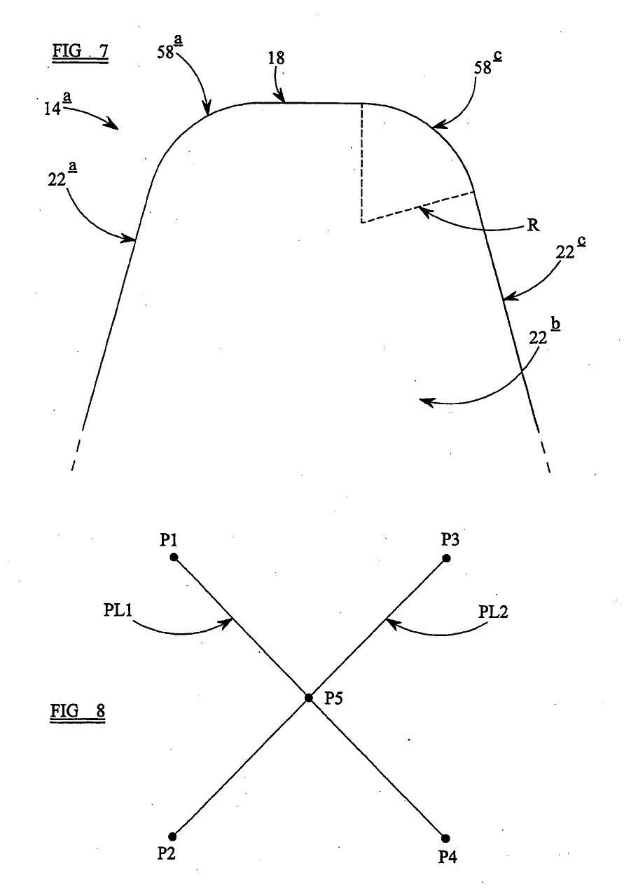

FIG. 7 is a section through a first form of apparatus according to a second aspect of the invention;

FIG. 8 illustrates the pattern of light projected onto a surface when light is passed through the apparatus of FIG. 7;

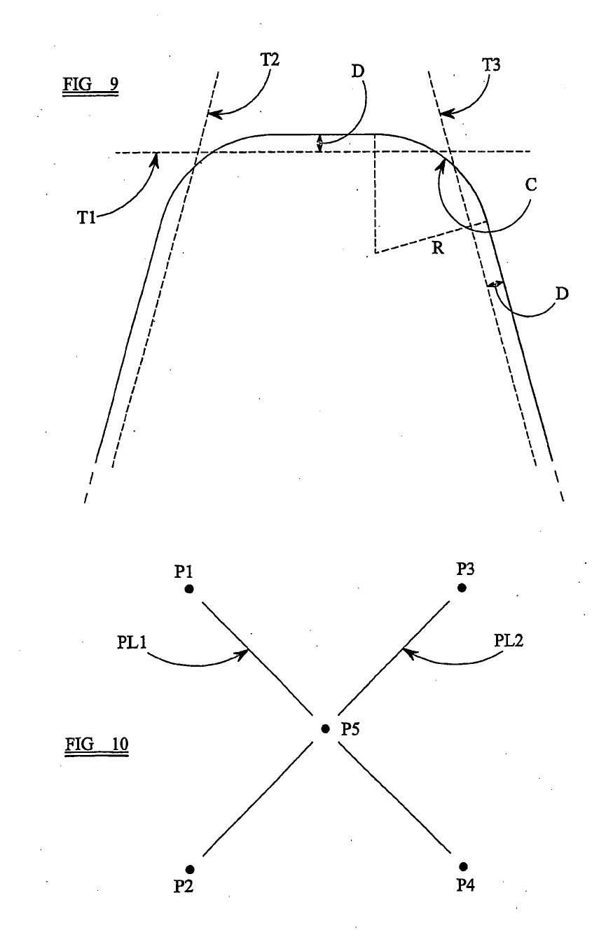

FIG. 9 is a section through a second, preferred form of apparatus according to the second aspect of the invention; and

FIG. 10 illustrates the pattern of light projected onto a surface when light is passed through the apparatus of FIG. 9;

It will be understood that the terms “vertical plane”, “horizontal plane” and any variations thereof are used in a relative sense to refer merely to two mutually perpendicular planes and are not intended to be in any way limiting as to direction or orientation.

Referring to FIG. 1, a preferred form of apparatus according to a first aspect of the invention is shown, in side elevation, generally at 10. The apparatus 10 comprises alight source in the form of a laser 12 in front of which is mounted, substantially exactly aligned therewith and at a predetermined distance therefrom, optical means in the form of a prism 14. In order to ensure the accurate positioning of the prism 14 with respect to the laser 12, both the laser and prism are mounted in a substantially cylindrical body or housing 16.

As best illustrated in FIG. 2, the prism 14 takes the form of a truncated pyramid having generally parallel end surfaces 18, 20. The first end surface 18, i.e. the face proximal to the laser 12, is generally square in shape and has an area of approximately 1 m². The second end surface 20, i.e. the face distal to the laser 12, forms the base of the pyramid and is generally circular, the prism conveniently being formed from a cylindrical block of suitable material having a diameter of approximately 4 mm The sides of the prism comprise four, generally flat, sloping surfaces or facets 22a, 22b, 22c, 22d joining the first and second end surfaces. It will be understood that, with the exception of a circular region immediately adjacent the base of the prism, the cross section of the prism is generally square.

The laser 12 advantageously has a beam diameter of approximately 3 mm, such that its area is somewhat larger than the area of the first end surface 18, but smaller than the area of the second end surface 20.

FIG. 3 illustrates how the light from the laser 12 is effected by the prism 14 which is disposed directly in front of the laser. As can be seen, owing to the greater area of the light beam relative to the first end surface of the prism 14, the light from the laser 12 is incident upon the first surface 18 of the prism 14 substantially at right angles whilst it strikes the four sloping surfaces 22a, 22b, 22c, 22d (surfaces 22b, 22d not shown) of the prism 14 at an angle of incidence which is dependent upon the pitch angle θ of the prism (i.e. the angle of the sloping surfaces relative to the central axis of the prism).

The light from the laser 12 which is incident substantially at right angles on the first surface 18 of the prism 14 (denoted as centre light beam L1) is substantially unaffected by the prism and passes directly therethrough with little or no change in direction. The light impinging upon each of the sloping surfaces 22a, 22b, 22c, 22d of the prism (denoted as light beams L2, L3), however, is affected by the refractive index of the prism 14 in the manner shown. More particularly, each of the beams L2, L3 incident upon the sloping surface 22a, 22c is refracted as it enters the prism 14 and again as it exits the prism at the base 20. Each of the beams L2, L3 therefore emerges from the second end surface 20 of the prism 14 diverging from the centre beam L1.

An example of the visible pattern of markers or indicators which is produced on a surface, such as a wall or other generally flat fixture, as a result of this optical mechanism is shown in FIG. 4a 4c. As can be seen in FIG. 4a, when the apparatus 10 is aligned substantially at right angles to the surface in both the horizontal and vertical planes, the pattern visible on the surface is of 4 points of light P1-P4, equidistantly spaced at 90° from one another about a central point of light P5. This pattern is referred to as a “dice 5” pattern. The actual or absolute distance between the points of light P1-P5 on the surface, assuming a generally symmetrical and substantially flawless prism is dependent upon the refractive index and the pitch angle θ of the prism 14, both of which determine the angle at which the beams of light L2, L3 diverge from the centre beam L1 (i.e. the amount of refraction of the light beams), and the distance of the apparatus 10 from the surface.

It will be understood, therefore, that, for a given apparatus aligned at right angles to the surface in both planes, the actual or absolute distance between the points of light P1-P5 is dependent on the distance of the apparatus from the surface. However, the relative positions of the points on the surface are dependent only upon the inclination, orientation or attitude of the apparatus relative to the surface.

For example, if the apparatus is misaligned in a horizontal plane relative to the surface (in this instance tilted above horizontal), the pattern of indicators may be similar to that shown in FIG. 4b. On the other hand, if the apparatus is misaligned with respect to the surface in only the vertical plane (in this instance inclined to the left of the vertical plane), then the pattern of indicators may be as shown in FIG. 3c. Clearly, if the apparatus is misaligned in both the horizontal and vertical planes, then the pattern will be a combination of the patterns of FIGS. 4b and 4c or a variation there of The relative positioning of the points in the pattern gives a visual indication of the alignment of the apparatus relative to the surface.

As shown in FIG. 5, the apparatus 10 may be formed in a single housing integral with a device such as a hand held drill 30 or the like. Alternatively, as illustrated in FIG. 6, the apparatus may be formed as part of an attachment 40 for individually attaching to a plurality of devices. In particular, such an attachment 40 could be mounted to a hand held drill by means of a mounting collar 42 which is arranged to mount on the collar 32 located at the base of the chuck 34 on the drill or by any other practical means. In this example, the apparatus may be activated by means of a two-stage trigger A, B, such that operation of the first stage trigger A activates the apparatus whilst operation of the second stage trigger B activates the drill.

The housing 16 is not an essential element since this serves mainly to align the prism with the laser, although a certain level of physical protection for the laser 12 and prism 14 is advantageously afforded by the housing. If such protection is not required, a simple framework or other means may be sufficient to align the laser and prism.

It will be appreciated that various modifications and improvements could be made to the apparatus of the invention. In particular, the apparatus may be powered by means of one or more batteries or power cells which are contained in the housing 16. Alternatively, where the apparatus is attached to an electrical device such as a power drill, the apparatus may be powered by means of the power supply for the device.

The use of a laser as the light source is not essential. Although a relatively power full light source is preferred to enable the apparatus to be effective in strong natural light, as is a source which produces a highly directional beam, the use of other types of light source such as laser diodes, light emitting diodes (LEDs) or conventional filament or gas discharge lamps may also be employed. Most preferably, the light source used to generate the beam of light is a relatively strong source of monochromatic, coherent light which produces a generally collimated beam. These characteristics are not essential but may assist in ensuring good definition and resolution of the projected image and high visibility even in circumstances where ambient light levels are high and the surface on which the image is projected has low reflectivity. A laser is considered most suitable but An optional lens 24 may be provided for focussing the beams of light thereby to adjust the size of the visible pattern of markers.

It will also be appreciated that the use of a prism is not essential. The invention relies on there being a plurality of visible markers projected or otherwise displayed on the surface in a predetermined pattern such that movement of the apparatus away from a substantially perpendicular alignment with the surface causes the pattern and relative positions of the markers to change. Consequently, an arrangement of reflectors (as opposed to a refractor) could be used in place of the prism. It is also possible to use a plurality of individual light sources set at fixed angles relative to one another, thereby to produce a plurality of spaced light points on the surface.

It will further be appreciated that the use of five markers spaced as shown in FIG. 3a is not essential. For an indication of inclination or deviation from perpendicular alignment to the surface in two planes, a minimum of three markers must be used, one for the horizontal plane, one for the vertical plane and one as a reference point. On the other hand,by suitably configuring the prism (or other optical mechanism) to have more than four side surfaces or facets, more than five markers can be used. It is envisaged that a particularly useful embodiment employs thirty-two or more side facets which conveniently form an almost circular pattern on the surface.

As more facets (and hence markers) are employed, the pattern further approaches that of a circle which considerably improves the sensitivity, resolution and/or interpretation of the pattern. Using such a pattern, the central light point or marker is not required as a reference which means that the prism can be formed without the flat first end surface 18. As the attitude of the apparatus relative to the surface changes, the shape of the pattern on the surface is distorted.

An example of an improved prism 14a suitable for use with the apparatus of FIG. 1, in which application it may be substituted for the prism of FIG. 2, is shown is cross-section in FIG. 7. Where possible, like reference numerals indicate like parts.

As in the embodiment of FIG. 2, the prism 14a takes the form of a truncated pyramid having generally plane parallel first and second end surfaces 18,20. The firs end surface 18 is generally square in shape and has an area which, preferably, is at least an order of magnitude smaller than the area of the second end surface 20. The second end surface 20 forms the base of the pyramid and is generally circular, this being a result of the prism conveniently being formed from a cylindrical block of suitable material. It will be understood that a prism having a generally square second end surface 20 is equally effective.

The absolute and/or relative sizes of the first and second end surfaces 18,20 are not critical but, advantageously, should be arranged so that the first end surface 18 has an area which is smaller than that of the light beam to be applied to the prism while the second end surface 20 has an area larger than that of the beam.

The side faces of the prism again comprise four, generally flat, sloping surfaces or facets 22a, 22b, 22c, 22d extending between the first and second end surfaces 18, 20. In the preferred embodiment, the sloping surfaces are inclined relative to the first and second end surfaces at an pitch angle θ of approximately 60°. This angle is not critical but, again, has an effect on the operation of the apparatus, as described below.

In contrast with the prism 14 illustrated in FIG. 2, the sloping side surfaces 22a -22d of the embodiment of FIG. 7 do not meet the edges of the first end surface 18 of the prism 14a at well-defined apices. Instead, an arcuate surface portion 58a-58d merges substantially tangentially with a respective edge of the first end portion 18 and a respective side surface of the prism 22a -22d. Preferably, each arcuate surface portion defines an arc of a circle having a predeternined radius R. The value of R is not critical but may have an effect on the pattern of light produced by the prism, as described below.

It will be understood by those skilled in the art that the arcuate surface portions 58a-58d can be readily machined or otherwise cut into the prism and further discussion of the methods involved in forming these portions will not be made.

FIG. 8 illustrates the pattern of light projected onto a surface when light is passed through the prism 14a of FIG. 7. As can be seen, the pattern exhibits the dice five pattern of the prism 14 of FIG. 2 but additionally produces two generally orthogonal, substantially straigt lines PL1,PL2. The lines PL1,PL2 connect, respectively, the two pairs of diametrically opposed points P1,P4 and P2,P3 and intersect at the point P5. It is believed that the projection of the straight lines PL1,PL2 is caused by a combined refraction and diffraction effect generated by the arcuate surface portions 58a-58d of the prism 10a. The direction of the straight lines PL1, PL2 is dependent on the orientation of the prism 14a relative to the surface.

Although not clearly shown in FIG. 8, in practice the lines PL1,PL2 tend to merge with, and partially obscure, the five points P1-P5. In an improvement shown in FIG. 9, therefore, it is proposed to truncate the first end surface 18 and the side surfaces 22a-22d of the prism 14a, for example along planes defined by the dotted truncation lines T1, T2 and T3. In this manner, each arcuate surface portion 58a-58d does not merge tangentially (i.e. substantially smoothly) with the first end surface 18 and the respective side surface 22a-22d, but rather connects these surfaces via respective apices. Again, it will be fully understood by those skilled in the art as to how such truncation of the prism can be achieved.

FIG. 10 illustrates the pattern projected onto a surface when light is passed through a prism when truncated in this way. As can be seen, the orthogonal lines PL1,PL2 are significantly shorter than in the previous embodiment and do not physically intersect one another. Instead, the lines do not extend fully to the four outer points P1-P4 or inwardly to the centre point P5. There is thus a visible gap between the outer ends of the lines PL1,PL2 and the respective outer points P1-P4 and also between the inner ends of the lines and the centre point P5.

If truncation of the prism is made only along the truncation lines T2 and T3, such that each arcuate surface portion meets the respective side surface at an apex but merges with the first end surface 12 tangentially (i.e. substantially smoothly), then the pattern projected on the surface may appear similar to that of FIG. 6 but with the lines PL1,PL2 intersecting orthogonally through the centre point P5. Alternatively, if truncation of the prism is made only along the truncation line T1, then the pattern will be such that the outer ends of the respective lines extend fully to the outer points P1-P4 but do not extend inwardly to the centre point P5 and do not intersect

It will be understood that the amount or depth of truncation of the prism, shown as truncation depth D, determines the length C of the arcuate surface portion 58a-58d for a given radius R It has been found that reducing the length of each arcuate portion 58a-58dfor example by increasing the truncation depth D, has the effect of shortening the orthogonal lines PL1,PL2. In addition, the arcuity or curvature of each arcuate surface portion appears to have an effect on the light intensity of the lines PL1,PL2. It has been found that increasing the curvature of the arcuate surface portion (i.e. reducing R) has the effect of increasing the light intensity of the lines PL1, PL2.

The material used to form the prism can be selected as desired although it will obviously be appreciated that the material used must be translucent. However, the material selected advantageously may have a refractive index in the range 1.6 to 2.5 and preferably in the range 1.7 to 2.2. In addition, the material preferably does not exhibit the phenomenon of double refraction, this being where a ray of light entering the material is divided into two separate beams which are refracted at two different angles. Suitable materials therefore may include cubic zirconia and, most preferably, spinel or synthesised materials having optical properties similar to spinel.

It will also be understood that materials having different optical properties, and in particular different refractive indices, may require a change in pitch angle θ in order to project the correct pattern on the surface. For example, the higher the refractive index of the material used, the smaller the pitch angle of the prism may be required and vice versa

The number of side surfaces may be greater than four if desired such that the cross section of the prism along the line A-A′ in FIG. 2 is polygonal. It will be understood that increasing the number of side surfaces may correspondingly increase the number of points projected and, if each side connects with the first end surface by a respective arcuate surface portion, may also increase the number of lines projected.

Inclination of the apparatus 10 incorporating the prism 14a relative to the surface causes a movement of the four outer points of light P1-P4 on the surface by an amount which is dependent upon the angle of inclination of the alignment apparatus relative to the surface. Whilst movement of the orthogonal lines PL1,PL2 also occurs through such inclination of the alignment apparatus, this movement is significantly less than that of the outer points P1-P4 such that it is substantially invisible to a user. Inclination of the alignment apparatus therefore causes the user to see an apparent movement of the outer points P1-P4 either towards or away from the orthogonal lines PL1,PL2 but little or no movement of the orthogonal lines themselves. By adjusting the inclination of the alignment apparatus relative to the surface until the outer points of light P1-P4 are substantially equidistant from the ends of the respective lines PL1,PL2, the user can achieve substantially perpendicular alignment of the apparatus relative to the surface.

In addition, whilst the alignment of the apparatus, and hence of any device to which the apparatus is attached, substantially at right angles to the surface can easily be achieved, it will be appreciated that it is possible to use the apparatus to achieve alignments other than at right angles to the surface. For example, it may be desired to align a device at, say, 45° to the horizontal but with no deviation relative to the vertical plane. Since the apparatus produces a unique pattern on the surface for every orientation or attitude relative to the surface, such an alignment is easily achieved if the user is aware of the pattern to look for.

To assist in this, it is envisaged that a patterned “template” or the like could be used for indicating the patterns produced for various orientations of the apparatus relative to the surface. The template may have a central marker, representative of the central light point produced by the apparatus, and additional markers representative of the expected pattern of light points at predetermined attitudes of the apparatus relative to the surface. In use, the user positions the template on the surface at the desired point, e.g. a point at which it is desired to drill, and identifies the relevant markers on the template corresponding to the expected pattern for the desired orientation of the device. The user then simply adjusts the attitude of the device until the pattern of light points produced by the apparatus match up with the corresponding markers on the template.

It will be appreciated that the present invention provides a simple and effective way of indicating the alignment of a device relative to a surface.

In addition, the prisms 14, 14a described and shown in FIGS. 2, 7 and 9 may find alternative application where it is desired to project a pattern of light onto a surface for aesthetic purposes. The most common application for such apparatus is in disco lighting equipment or the like.

Known forms of disco lighting apparatus use one or more light sources, for example fluorescent light bulbs, whose light is projected onto a wall or ceiling through a movable or adjustable shutter arrangement. Movement of the shutter arrangement changes the pattern of light projected onto the wall or ceiling.

Other known forms of disco lighting apparatus use a laser which projects an intense beam of light onto a surface such as a wall or ceiling via an adjustable reflector arrangement. The reflector arrangement usually comprises a plurality of mirrors and can be rotated or otherwise moved in order to change the pattern of light projected onto the surface.

These forms of apparatus are generally relatively bulky and involve a number of complex moving parts. This makes them unsuitable for portable applications or applications where low cost and good reliability are important. In addition, the use of moving shutters or reflector arrangements can degrade the image or pattern projected on the surface giving a “blurred” effect. This may be acceptable for disco lighting systems but limits the use of such devices in other applications.

The present invention may be used for such disco lighting systems, reducing cost and complexity and providing the benefit of small size and light weight.

1. An apparatus for facilitating the alignment of an object with respect to a surface, the apparatus comprising means, mountable on said object, for providing a plurality of visible markers or indicators onto said surface in a predetermined pattern, configuration or spacing such that a change in the attitude or orientation of said apparatus relative to said surface causes a change in the pattern, configuration or spacing of said indicators or markers on said surface.

2. An apparatus according to claim 1 wherein said means comprises a light source for projecting a beam of light and optical means for splitting the beam into a plurality of light beams.

3. An apparatus according to claim 2 wherein said optical means comprises a refractor or the like.

4. An apparatus according to claim 3 wherein the refractor comprises a prism arranged to split the beam of light into five light beams.

5. An apparatus according to claim 4 wherein said five light beams are arranges as a central beam and four mutually diverging beams substantially equidistantly spaced about said central beam and generally at 90E to each other.

6. An apparatus for refracting a beam of light, the apparatus comprising prism means having a first end surface, a plurality of inclined side surfaces and a corresponding plurality of arcuate surfaces connecting the first end surface to a respective side surface, the arrangement being such that when the light beam is passed through the prism means and projected onto a surface, a predetermined pattern comprising a plurality of generally straight lines is displayed thereon.

7. An apparatus as claimed in claim 6 wherein the predetermined pattern comprises two generally straight lines which intersect substantially at right angles.

8. An apparatus as claimed in claim 6 wherein the pattern may additionally include a plurality of discrete points or dots of light.

9. An apparatus as claimed in claim 8 wherein the arrangement is such that inclination of the apparatus relative to the surface causes relative movement between at least one of the dots and at least one of the lines.

10. An apparatus as claimed in claim 6 wherein the cross section of the prism means in a first plane is substantially trapezoidal.

11. An apparatus as claimed in claim 6 wherein the prism means includes at least four inclined side surfaces.

12. An apparatus as claimed in claim 6 wherein the side surfaces are inclined relative to the first end surface at an angle of approximately 60E.

13. An apparatus as claimed in claim 6 wherein the prism means is formed from a material which does not exhibit double refraction.

14. An apparatus as claimed in claim 6 wherein the prism means is formed from a material having a refractive index of between 1.712 and 1.762.

15. An apparatus as claimed in claim 6 wherein the prism means is formed from spinel.
